(19) United States
(12) Patent Application Publication
(10) Pub. No.: US 2014/0009030 A1
(43) Pub. Date: Jan. 9, 2014

(54) FAN STATOR STRUCTURE

(71) Applicant: Chu-Hsien Chou, New Taipei City (TW)

(72) Inventor: Chu-Hsien Chou, New Taipei City (TW)

(21) Appl. No.: 13/542,966

(22) Filed: Jul. 6, 2012

(51) Int. Cl. H02K 1/16

(52) U.S. Cl. 310/216.004

(57) ABSTRACT

A fan stator structure includes a stator assembly having at least one first silicon steel sheet and at least one second silicon steel sheet. The second silicon steel sheet has a base section and at least one magnetic conductive section extending from the base section. The first and second silicon steel sheets are stacked to form the stator assembly. By means of the first and second silicon steel sheets, the position of the magnetic force center of the stator assembly so as to reduce noise and wear ratio and prolong the lifetime of the fan.

### BACKGROUND OF THE INVENTION

1. Field of the Invention

The present invention relates generally to a fan stator structure, and more particularly to a fan stator structure, which is able to change the position of the magnetic force center of the stator so as to greatly reduce noise and wear ratio of the fan and prolong the lifetime of the fan.

2. Description of the Related Art

In the modern society, cooling fans with heat dissipation function have become very important components in various electronic products. The cooling fans are applied to many electronic devices ranging from small-size portable electronic devices to large-size electronic equipments of transportation tools. When an electronic device operates, high heat is often generated at the same time to affect the working efficiency of the electronic device or even cause crash of the electronic device. Therefore, the electronic device generally needs a cooling fan to dissipate the heat and lower the temperature of the electronic device so as to keep the electronic device stably working. The reliability and durability of the fan itself are also key factors to ensure that the electronic device works stably.

Therefore, nowadays, all the existent fan manufacturers are striving to develop more diversified fans to satisfy various heat dissipation requirements.

A conventional fan is composed of a stator assembly and a rotor. When the fan operates, the rotor rotates relative to the stator due to the change of polarity. In high-speed operation, the impeller of the fan tends to irregularly shake. After a long period of shaking and collision, the bearing of the fan is subject to serious wear of the shaft of the impeller. Under such circumstance, the fan will make mechanical noise in operation and the lifetime of the fan will be shortened. Moreover, the silicon steel sheets of the conventional stator assembly are all in the form of plane sheet. In this case, the center of magnetic force can be controlled only by the center of the thickness of the stacked silicon steel sheets. As a result, the center of magnetic force can be hardly kept in an optimal position.

According to the above, the conventional technique has the following shortcomings:

1. The noise is increased.

2. The wear ratio is increased.

3. The lifetime of the fan is shortened.

### SUMMARY OF THE INVENTION

It is therefore a primary object of the present invention to provide a fan stator structure, which is able to change the position of the magnetic force center of the stator so as to reduce noise and wear ratio of the fan and prolong the lifetime of the fan.

It is a further object of the present invention to provide the above fan stator structure in which the magnetic conductive area of the stator assembly is enlarged to enhance the operation efficiency of the motor.

To achieve the above and other objects, the fan stator structure of the present invention includes a stator assembly having at least one first silicon steel sheet and at least one second silicon steel sheet. The second silicon steel sheet has a base section and at least one magnetic conductive section. The magnetic conductive section extends from at least one side of the base section. The first and second silicon steel sheets are stacked to form the stator assembly. The first silicon steel sheet has a first end face and a second end face. The second silicon steel sheet is selectively attached to one of the first and second end faces.

The first and second silicon steel sheets are stacked to form the stator assembly. The magnetic conductive section of the second silicon steel sheet is able to change the position of the magnetic force center of the stator and the rotor so as to increase or change the attraction force. Accordingly, the mechanical noise and wear caused by the vibration in operation of the fan can be greatly reduced and the lifetime of the fan can be prolonged. Moreover, the magnetic conductive section of the second silicon steel sheet has a certain area to greatly increase the magnetic conductivity of the stator assembly. In this case, the operation efficiency of the motor can be enhanced.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1A is a perspective exploded view a first embodiment of the fan stator structure of the present invention;

FIG. 1B is a perspective assembled view the first embodiment of the fan stator structure of the present invention;

FIG. 2 is a perspective exploded view of a second embodiment of the fan stator structure of the present invention;

FIG. 3 is a perspective exploded view of a third embodiment of the fan stator structure of the present invention;

FIG. 4 is a perspective exploded view of a fourth embodiment of the fan stator structure of the present invention;

FIG. 5A is a perspective exploded view of a fifth embodiment of the fan stator structure of the present invention;

FIG. 5B is a perspective exploded view of the fifth embodiment of the fan stator structure of the present invention;

FIG. 6A is a perspective exploded view of a sixth embodiment of the fan stator structure of the present invention;

FIG. 6B is a perspective assembled view of the sixth embodiment of the fan stator structure of the present invention; and

FIG. 6C is another perspective exploded view of the sixth embodiment of the fan stator structure of the present invention.

FIG. 7 is another perspective exploded view of the seventh embodiment of the fan stator structure of the present invention.

### DETAILED DESCRIPTION OF THE PREFERRED EMBODIMENTS

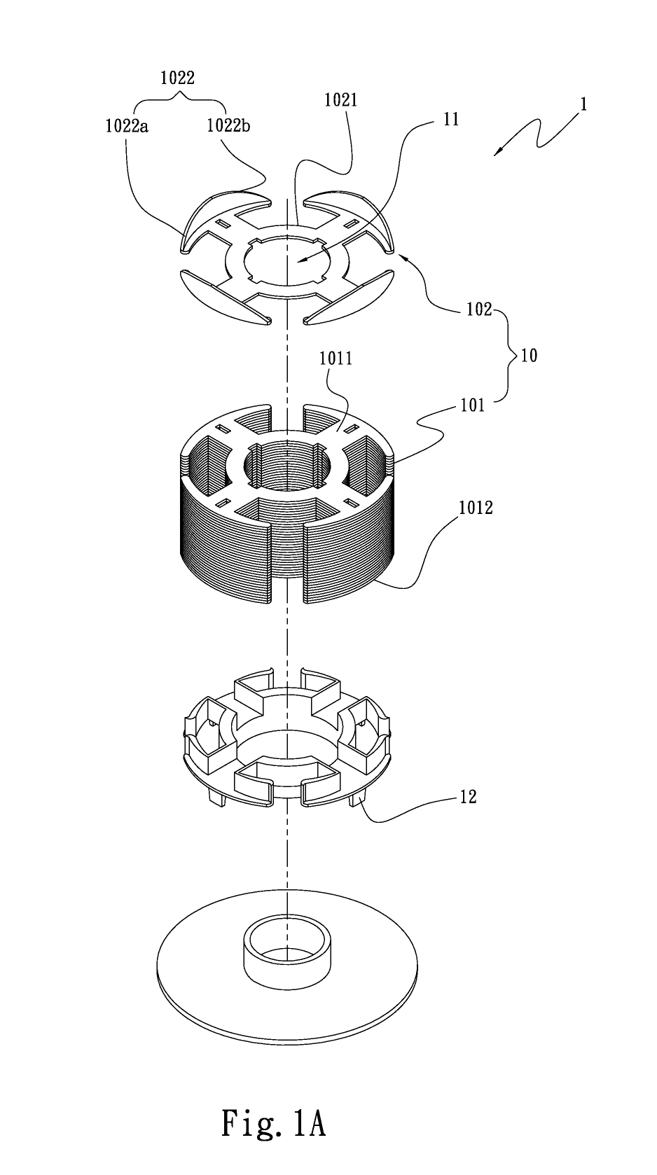

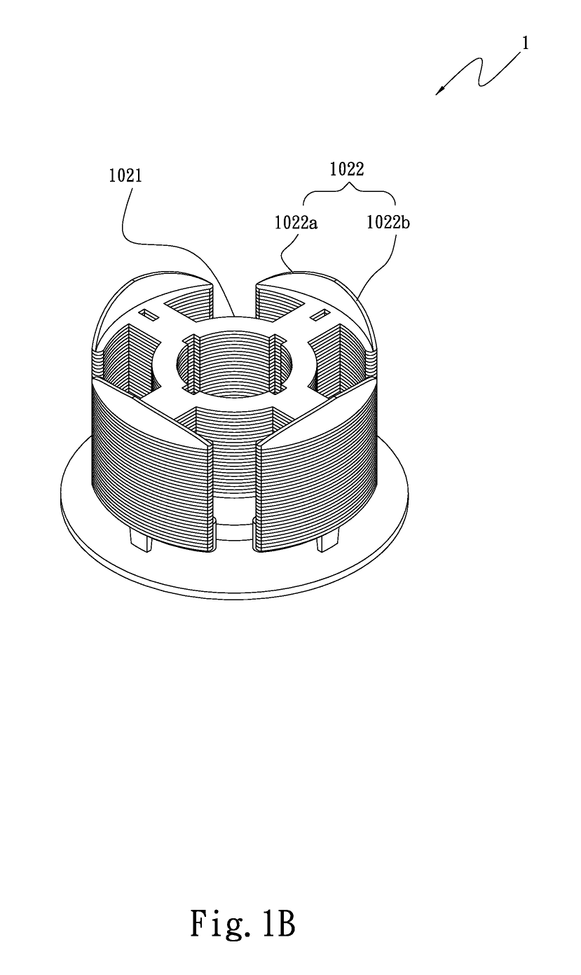

Please refer to FIGS. 1A and 1B. FIG. 1A is a perspective exploded view a first embodiment of the fan stator structure of the present invention. FIG. 1B is a perspective assembled view the first embodiment of the fan stator structure of the present invention. According to the first embodiment, the fan stator structure 1 of the present invention includes a stator assembly 10 having at least one first silicon steel sheet 101 and at least one second silicon steel sheet 102. The second silicon steel sheet 102 has a base section 1021 and at least one magnetic conductive section 1022. The magnetic conductive section 1022 perpendicularly extends from at least one side of the base section 1021. The first and second silicon steel sheets 101, 102 are stacked to form the stator assembly 10.

The stator assembly 10 further has a through hole 11 and multiple poles 12. The through hole 11 axially passes through the first and second silicon steel sheets 101, 102. The magnetic conductive sections 1022 are disposed at free ends of the poles 12. The magnetic conductive section 1022 has a first magnetic conductive end 1022a and a second magnetic conductive end 1022b. The first and second magnetic conductive ends 1022a, 1022b have equal lengths.

The first silicon steel sheet 101 has a first end face 1011 and a second end face 1012. The second silicon steel sheet 102 is attached to the first end face 1011 of the first silicon steel sheet 101. As aforesaid, the first and second silicon steel sheets 101, 102 are stacked to form the stator assembly 10. When the fan operates, the rotor rotates relative to the stator due to the change of polarity. The magnetic conductive section 1022 of the second silicon steel sheet 102 is able to change the position of the magnetic force center of the stator and the rotor so as to increase or change the attraction force. Accordingly, the mechanical noise and wear caused by the vibration in operation of the fan can be greatly reduced and the lifetime of the fan can be prolonged. Moreover, the magnetic conductive section 1022 of the second silicon steel sheet 102 has a certain area to greatly increase the magnetic conductivity of the stator assembly 10. In this case, the operation efficiency of the motor can be enhanced.

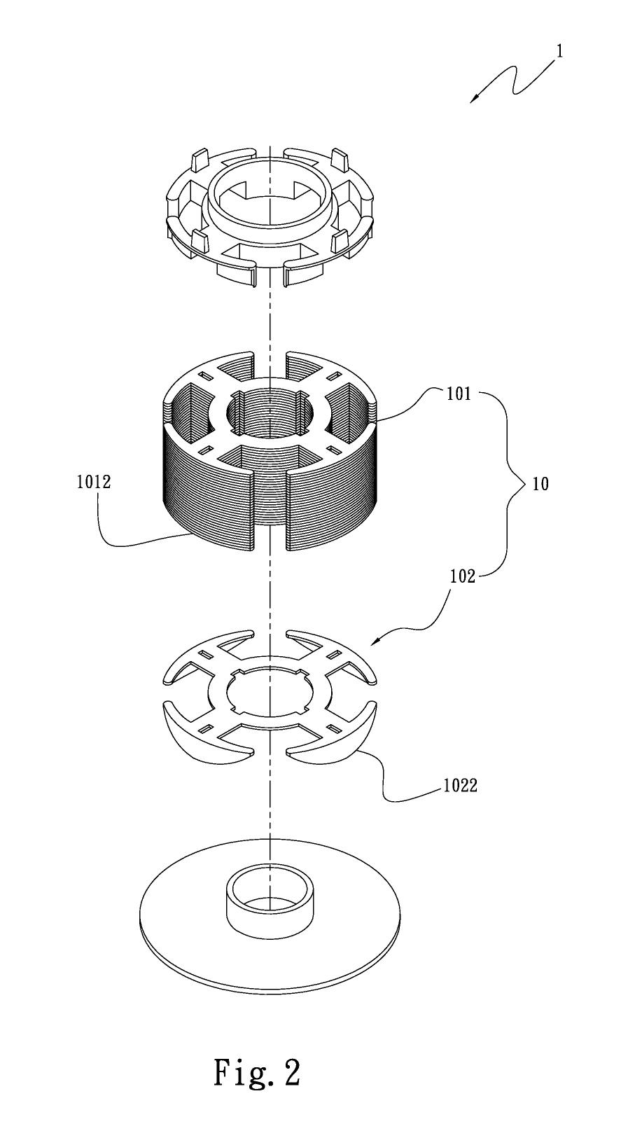

Please now refer to FIG. 2, which is a perspective exploded view of a second embodiment of the fan stator structure of the present invention. The second embodiment is partially identical to the first embodiment in components and connection relationship between the components and thus will not be repeatedly described hereinafter. The second embodiment is mainly different from the first embodiment in that the second silicon steel sheet 102 is attached to the second end face 1012 of the first silicon steel sheet 101. As aforesaid, the first and second silicon steel sheets 101, 102 are stacked to form the stator assembly 10. When the fan operates, the magnetic conductive section 1022 of the second silicon steel sheet 102 is able to change the position of the magnetic force center of the stator and the rotor so as to increase or change the attraction force. Accordingly, the mechanical noise and wear caused by the vibration in operation of the fan can be reduced and the lifetime of the fan can be prolonged.

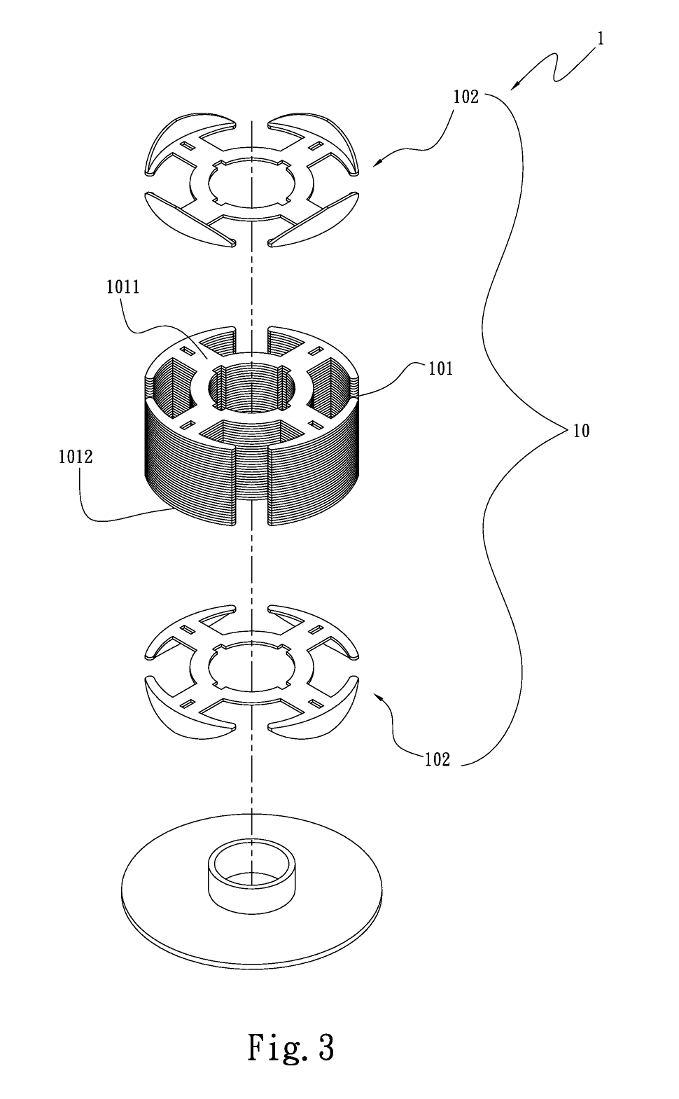

Please now refer to FIG. 3, which is a perspective exploded view of a third embodiment of the fan stator structure of the present invention. The third embodiment is partially identical to the first embodiment in components and connection relationship between the components and thus will not be repeatedly described hereinafter. The third embodiment is mainly different from the first embodiment in that the second silicon steel sheets 102 are disposed on both the first and second end faces 1011, 1012 of the first silicon steel sheets 101. As aforesaid, the first and second silicon steel sheets 101, 102 are stacked to form the stator assembly 10. When the fan operates, the magnetic conductive sections 1022 of the second silicon steel sheets 102 are able to change the position of the magnetic force center of the stator and the rotor so as to increase or change the attraction force. Accordingly, the mechanical noise and wear caused by the vibration in operation of the fan can be greatly reduced and the lifetime of the fan can be prolonged.

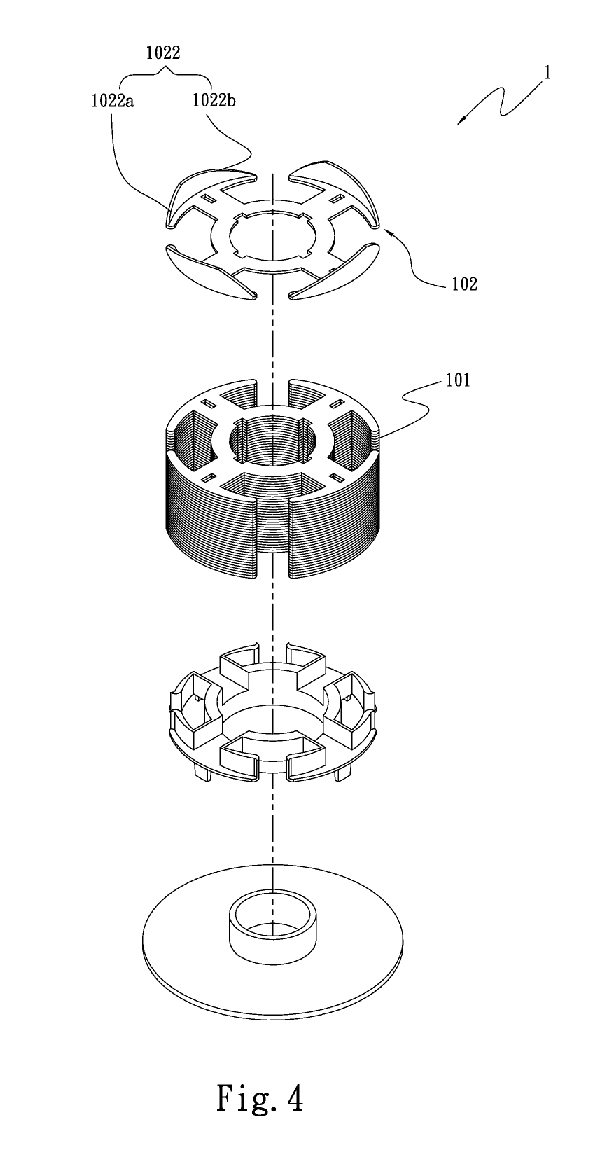

Please now refer to FIG. 4, which is a perspective exploded view of a fourth embodiment of the fan stator structure of the present invention. The fourth embodiment is partially identical to the first embodiment in components and connection relationship between the components and thus will not be repeatedly described hereinafter. The fourth embodiment is mainly different from the first embodiment in that the first and second magnetic conductive ends 1022a, 1022b have unequal lengths. Accordingly, the lengths of the first and second magnetic conductive ends 1022a, 1022b can be changed as necessary. In this case, the position of the magnetic force center of the stator and the rotor is variable with the lengths of the first and second magnetic conductive ends 1022a, 1022b so as to increase or change the attraction force. Accordingly, the mechanical noise and wear caused by the vibration in operation of the fan can be reduced and the lifetime of the fan can be prolonged.

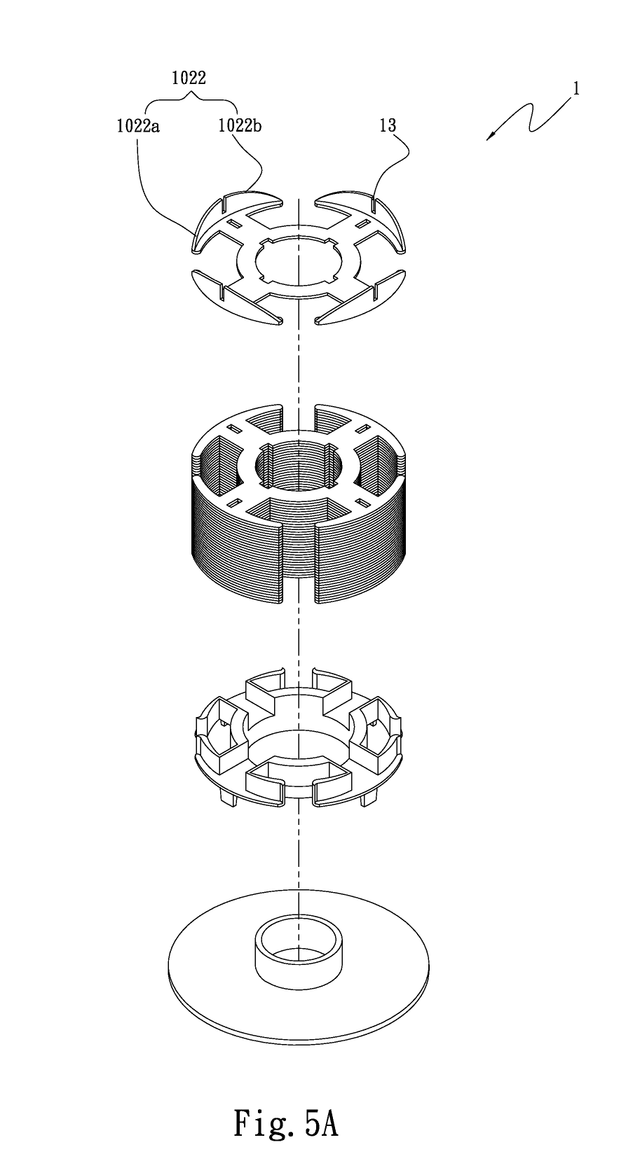

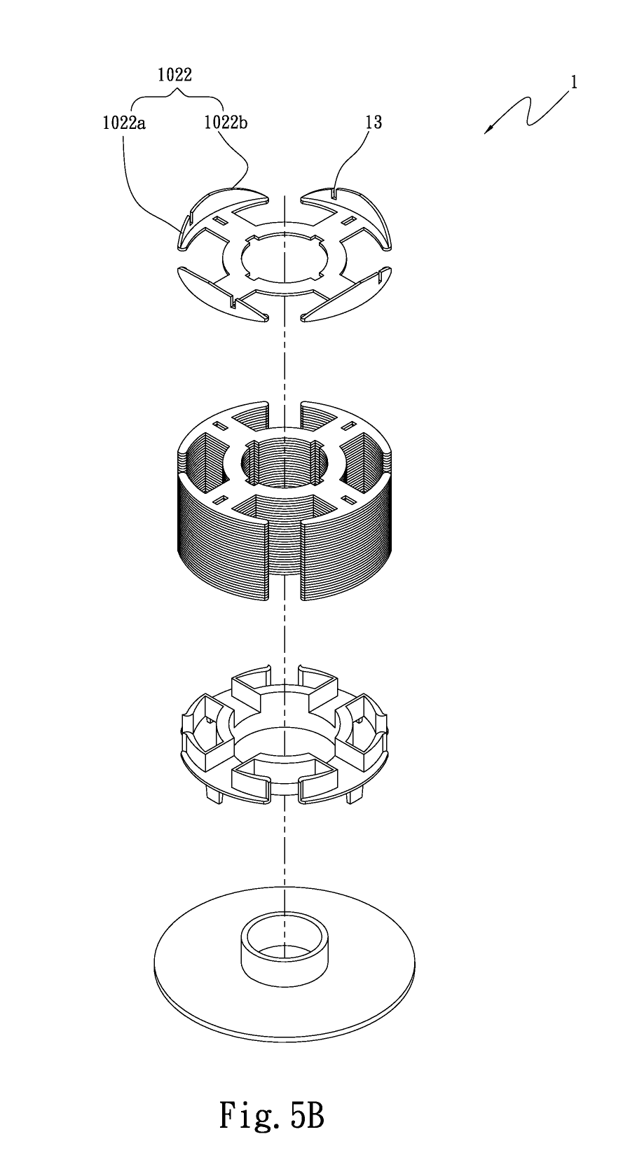

Please now refer to FIGS. 5A and 5B, which are perspective exploded views of a fifth embodiment of the fan stator structure of the present invention. The fifth embodiment is partially identical to the first embodiment in components and connection relationship between the components and thus will not be repeatedly described hereinafter. The fifth embodiment is mainly different from the first embodiment in that the magnetic conductive section 1022 is further formed with a notch 13. The notch 13 is formed at the junction between the first and second magnetic conductive ends 1022a, 1022b (as shown in FIG. 5A) or formed on one of the first and second magnetic conductive ends 1022a, 1022b (as shown in FIG. 5B). In this embodiment, the notch 13 is formed on, but not limited to, the first magnetic conductive end 1022a for illustration purposes only. Alternatively, the notch 13 can be formed on the second magnetic conductive end 1022b (not shown).

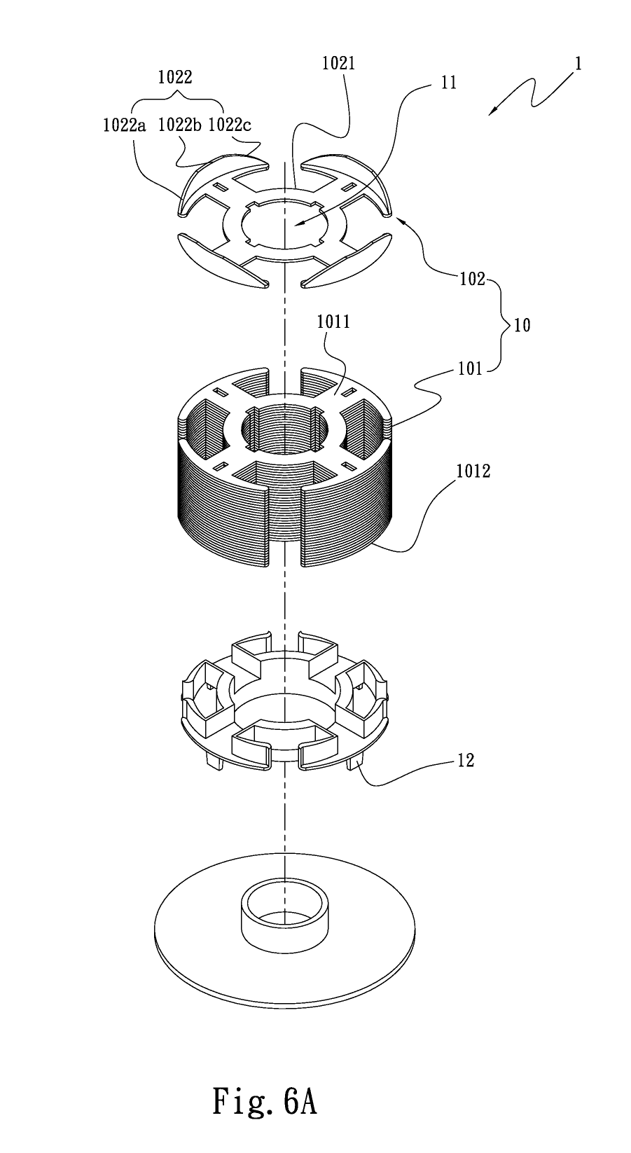

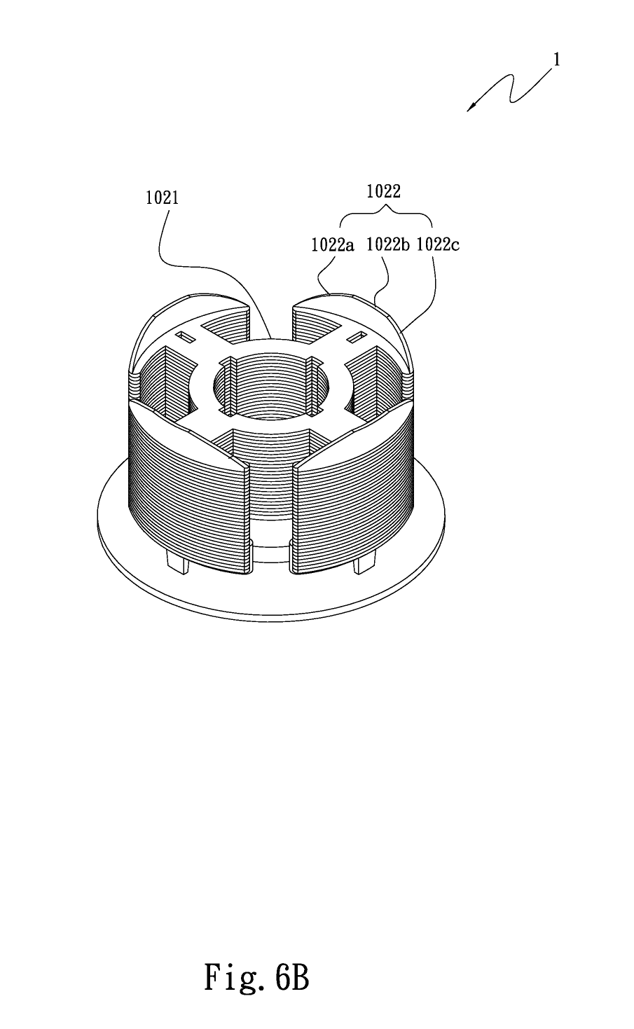

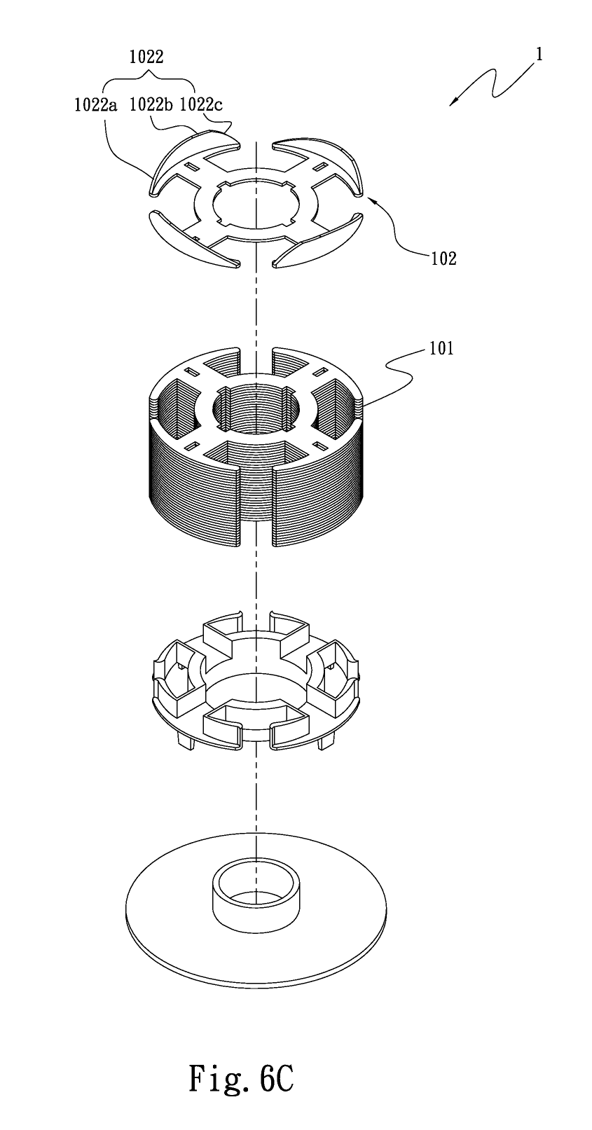

Please now refer to FIGS. 6A, 6B and 6C. FIG. 6A is a perspective exploded view of a sixth embodiment of the fan stator structure of the present invention. FIG. 6B is a perspective assembled view of the sixth embodiment of the fan stator structure of the present invention. FIG. 6C is another perspective exploded view of the sixth embodiment of the fan stator structure of the present invention. The sixth embodiment is partially identical to the first embodiment in components and connection relationship between the components and thus will not be repeatedly described hereinafter. The sixth embodiment is mainly different from the first embodiment in that the magnetic conductive section 1022 further has a third magnetic conductive end 1022c. The first, second and third magnetic conductive ends 1022a, 1022b, 1022c can have equal lengths (as shown in FIG. 6A) or unequal lengths (as shown in FIG. 6C). The lengths of the first, second and third magnetic conductive ends 1022a, 1022b, 1022c can be changed as necessary. In this case, the position of the magnetic force center of the stator and the rotor is variable with the lengths of the first, second and third magnetic conductive ends 1022a, 1022b, 1022c so as to increase or change the attraction force. Accordingly, the mechanical noise and wear caused by the vibration in operation of the fan can be reduced.

As aforesaid, the first and second silicon steel sheets 101, 102 are stacked to form the stator assembly 10. When the fan operates, the magnetic conductive section 1022 of the second silicon steel sheet 102 is able to change the position of the magnetic force center of the stator and the rotor so as to increase or change the attraction force. Accordingly, the mechanical noise and wear caused by the vibration in operation of the fan can be greatly reduced and the lifetime of the fan can be prolonged. Moreover, the magnetic conductive section 1022 of the second silicon steel sheet 102 has a certain area to greatly increase the magnetic conductivity of the stator assembly 10. In this case, the operation efficiency of the motor can be enhanced.

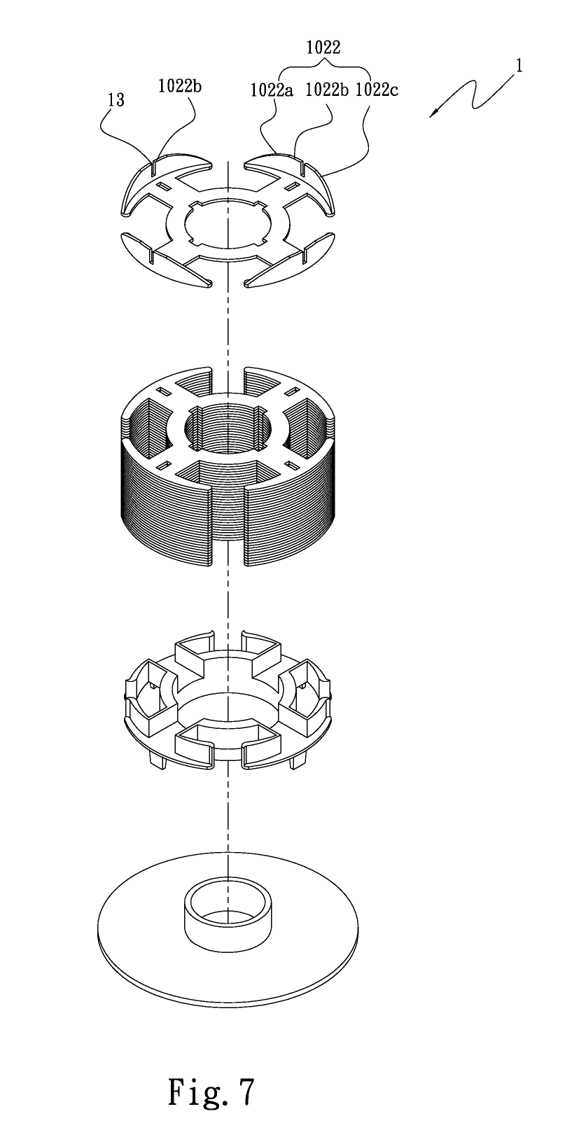

Please now refer to FIG. 7, which is a perspective exploded view of a seventh embodiment of the fan stator structure of the present invention. The seventh embodiment is partially identical to the sixth embodiment in components and connection relationship between the components and thus will not be repeatedly described hereinafter. The seventh embodiment is mainly different from the sixth embodiment in that the notch 13 is formed on one of the first, second and third magnetic conductive ends 1022a, 1022b, 1022c. In this embodiment, the notch 13 is formed on, but not limited to, the second magnetic conductive end 1022b for illustration purposes only. Alternatively, the notch 13 can be formed on the first magnetic conductive end 1022a or the third magnetic conductive end 1022c (not shown).

According to the above arrangement, in comparison with the conventional technique, the present invention has the following advantages:

1. The noise is reduced.

2. The wear ratio is lowered.

3. The lifetime of the fan is prolonged.

4. The operation efficiency of the motor is enhanced.

The present invention has been described with the above embodiments thereof and it is understood that many changes and modifications in the above embodiments can be carried out without departing from the scope and the spirit of the invention that is intended to be limited only by the appended claims.

What is claimed is:

1. A fan stator structure comprising a stator assembly having at least one first silicon steel sheet and at least one second silicon steel sheet, the second silicon steel sheet having a base section and at least one magnetic conductive section, the magnetic conductive section extending from at least one side of the base section, the first and second silicon steel sheets being stacked to form the stator assembly.

2. The fan stator structure as claimed in claim 1, wherein the first silicon steel sheet has a first end face and a second end face, the second silicon steel sheet being selectively attached to one of the first and second end faces.

3. The fan stator structure as claimed in claim 2, wherein the second silicon steel sheets are disposed on both the first and second end faces of the first silicon steel sheet.

4. The fan stator structure as claimed in claim 1, wherein the stator assembly further has a through hole axially passing through the first and second silicon steel sheets.

5. The fan stator structure as claimed in claim 1, wherein the stator assembly further has multiple poles, the magnetic conductive sections being disposed at free ends of the poles.

6. The fan stator structure as claimed in claim 5, wherein the magnetic conductive section has a first magnetic conductive end and a second magnetic conductive end, the first and second magnetic conductive ends having equal or unequal lengths.

7. The fan stator structure as claimed in claim 6, wherein the magnetic conductive section is further formed with a notch, the notch being formed at a junction between the first and second magnetic conductive ends.

8. The fan stator structure as claimed in claim 7, wherein the notch is formed on one of the first and second magnetic conductive ends.

9. The fan stator structure as claimed in claim 8, wherein the magnetic conductive section further has a third magnetic conductive, the first, second and third magnetic conductive ends having equal or unequal lengths.

10. The fan stator structure as claimed in claim 9, wherein the notch is formed on one of the first, second and third magnetic conductive ends.
